(19) United States
(12) Patent Application Publication
(10) Pub. No.: US 2025/0194719 A1
(43) Pub. Date: Jun. 19, 2025

(54) APPAREL ARTICLE WITH TEXTURED GRIP

(71) Applicant: BakNer Manufacturing, LLC, Canton, GA (US)

(72) Inventors: Jason Baker, Hawkins, TX (US); Matthew Wagner, Canton, GA (US)

(73) Assignee: BakNer Manufacturing, LLC, Canton, GA (US)

(21) Appl. No.: 18/847,244

(22) PCT Filed: Mar. 13, 2023
(86) PCT No.: PCT/US23/15073

§ 371 Date: Sep. 14, 2024

Related U.S. Application Data
(60) Provisional application No. 63/319,411, filed on Mar. 14, 2022.

(51) Int. Cl. A41D 19/015; A43B 3/16

(52) U.S. Cl. CPC A41D 19/015; A43B 3/16

(57) ABSTRACT

An apparel article (12) with a grip texture on an exterior surface formed by a grip field of a plurality of spaced-apart nodules (16) extending from the exterior surface to a distal end and each defining a concave recess (44) therein. The apparel article may comprise (A) a glove body having a cuff with an open end and a hand portion from which four finger tubes and a thumb tube extend, for receiving a hand. and the exterior surface having at least one grip field for gripping an article and (B) a shoe cover with a sole having the grip field for resisting slippage on walking surfaces.

### TECHNICAL FIELD

The present invention relates to apparel articles for protective purposeful uses. More particularly, the present invention relates to apparel articles with textured surfaces for protective purposeful industrial and cleaning uses. More particularly, the apparel articles featuring textured surfaces are gloves for hand and finger protection and uses in the protected gripping of articles and shoe covers for protection of footwear while featuring textured soles for resistance to slipping on walking surfaces.

### BACKGROUND OF THE INVENTION

Apparel articles, such as protective rubber or polymeric material gloves made from natural or synthetic polymers are used for hygienic reasons, protection of the skin from contaminants and chemicals, and many other applications. These applications typically include protecting the user from the environment and, often, protecting the environment from the user; however, wearing these rubber gloves often interferes with the user's grip on articles such as for example but not limited to, tools and cleaning supplies. Additionally, shoe covers of protective rubber or polymeric material cover footwear in spill and materials containments, cleanup, and serving. The shoe covers provide sole surfaces with anti-slip features for protective and/or hygienic purposes.

Glove makers use several techniques to help enhance the grip of persons using protective gloves. One such technique is to make the polymer material tackier, thus providing a better grip for a person using the glove for glove purposes. A more common approach is to alter the physical glove surface in the form of a texture to provide a better grip.

Multiple grip patterns have been developed by roughening the surface or adding geometric patterns to help enhance the grip obtainable when using such protective gloves. Many grip patterns, such as in Furlong (U.S. D773744), Hull (U.S. Pat. No. 8,028,348), and Sood (U.S. Patent Publication No. 20160050993), are made of adjacent cavities in shapes such as fish scales, circles, or gridded ridge and valley shapes. In the case of Sood, the cavities are part of a ridge grid pattern that create adjacent cavities. In other formats, adjacent shapes, such as diamonds, are formed. However, in the current available grip textures, the geometry yields thick and thin spots along the surface. The thinner spots are often thinner than the non-textured part of the glove due to surface tension and physical trapping of the coagulant and latex dipping chemistry. The raised part of the texture pattern tends to rob the cavity areas of material, thus creating the thinner spots of the glove. These thinner spots become the weakest part of the glove and are normally the first areas breached by chemical permeation or by physical activity.

Similarly, shoe covers that protect footwear and feet may also experience relatively thinner portions as the texture patterns may led to chemistry materials flowing non-uniformly.

Accordingly, there is a need in the art for improved apparel articles with textured geometry for protective and utility purposes, and particularly gloves with a texture geometry that allows for enhanced grip while minimizing the weaker thin spots in the glove film and show covers with textured geometry for contacting surfaces while minimizing weaker thin portions of the sole. It is to such that the present invention is directed.

### SUMMARY OF THE INVENTION

The present invention meets the need in the art providing an apparel article, comprising a protective shell with an opening for receiving therethrough a portion of a person to wear the apparel good; and at least one grip field having a plurality of spaced-apart nodules, each nodule extending from an exterior surface of the protective shell to a distal end defining a concave recess therein.

The apparel article as recited in paragraph [0007], wherein each nodule defines a geometrix with a base at the exterior surface having a width in a range 0.5 mm to 5 mm, extends to a height in a range from 0.2 mm to 2 mm from the exterior surface, and the concave recess has a depth of 0.05 mm to 1 mm, and adjacent ones of the plurality of nodules are spaced apart in a range of 0.1 mm to 3 mm.

The apparel article as recited in paragraph [0007], wherein the protective shell defines a glove having a hand portion from which four finger tube and a thumb tube extend.

The apparel article as recited in paragraph [0007], wherein the protection shell defines a shoe covering.

The apparel article as recited in any of paragraphs [0007-0010], wherein each nodule extends to a height in a range from 0.2 mm to 2 mm from the exterior surface.

The apparel article as recited in any of paragraphs [0007-0010], wherein each nodule extends to a height of 0.8 mm.

The apparel article as recited in any of paragraphs [0007-0010], wherein the concave recess has a diameter of 0.2 mm to 1.5 mm.

The apparel article as recited in any of paragraphs [0007-0010], wherein the concave recess has a diameter of 1 mm.

The apparel article as recited in any of paragraphs [0007-0010], wherein the concave recess has a depth of 0.05 mm to 1 mm.

The apparel article as recited in any of paragraphs [0007-0010], wherein the concave recess has a depth of 0.1 mm.

The apparel article as recited in any of paragraphs [0007-0010], wherein the nodule extends outwardly with a side wall up to 90 degrees relative to the exterior surface.

The apparel article as recited in any of paragraphs [0007-0010], wherein the nodule angles to the distal end in a range of 15 degrees to 75 degrees relative to the exterior surface.

The apparel article as recited in any of paragraphs [0007-0010], wherein the nodule angles to the distal end at 45 degrees relative to the exterior surface.

The apparel article as recited in any of paragraphs [0007-0010], wherein the nodule has a base at the exterior surface with a width in a range 0.5 mm to 5 mm.

The apparel article as recited in any of paragraphs [0007-0010], wherein the nodule has a base at the exterior surface with a width of 2.3 mm.

The apparel article as recited in any of paragraphs [0007-0010], wherein adjacent ones of the plurality of nodules are spaced apart in a range of 0.1 mm to 3 mm.

The apparel article as recited in any of paragraphs [0007-0010], wherein adjacent ones of the plurality of nodules are spaced 1 mm apart.

The apparel article as recited in any of paragraphs [0007-0010], wherein the nodule defines a conical geometric shape with a base at the exterior surface having a width in a range 0.5 mm to 5 mm, extends to a height in a range from 0.2 mm to 2 mm from the exterior surface, and the concave recess has a depth of 0.05 mm to 1 mm, and adjacent ones of the plurality of nodules are spaced apart in a range of 0.1 mm to 3 mm.

The apparel article as recited in paragraph [0009], wherein the hand portion defines at least one pad portion; and the at least one grip field occupies the at least one pad portion.

The apparel article as recited in paragraph [0025], wherein the at least one grip field occupies a palm side tip portion of at least one of the four finger portions and the thumb portion.

The apparel article as recited in paragraph [0009], wherein each of the four finger tubes and the thumb tube have a respective palm-side tip portion and each respective palm-side tip portion having a respective one of the at least one grip field of the plurality of nodules.

The apparel article as recited in paragraph [0009], wherein the at least one pad portion is on a palm-side proximate the thumb tube.

The apparel article as recited in paragraph [0028], further comprising a second one of the at least one pad portion on a palm side proximate a finger tube most distally remote from the thumb tube; and further comprising a second one of the at least one grip field that occupies the second one of the at least one pad portion.

The apparel article as recited in any of paragraphs [0007-0010], wherein the plurality of spaced-apart nodules are disposed in rows.

The apparel article as recited in paragraph [0030], wherein the spaced-apart nodules in a first row are offset from the spaced-apart nodules in an adjacent row.

The apparel article as recited in any of paragraphs [0007-0010], wherein the nodule is conical.

The apparel article as recited in any of paragraphs [0007-0010], wherein the nodule is pyramidal.

The apparel article as recited in any of paragraphs [0007-0010], wherein the nodule is circular in cross-section.

The apparel article as recited in paragraph [0010], wherein the exterior surface of the protective shell comprises a sole portion of the shoe covering.

In another aspect, the present invention meets the need in the art by providing a glove with a grip texture, comprising a glove body having an exterior surface, with a cuff having an open end and extending to a hand portion from which four finger tubes and a thumb tube extends, for receiving a hand therein; and at least one grip field having a plurality of spaced-apart geomtrix, each extending from the exterior surface to a distal end defining a concave recess therein.

The glove as recited in paragraph [0036], wherein the grip field is defined on a respective palm-side tip portion of the finger tubes and the thumb tube.

The glove as recited in paragraph [0036], wherein the grip field is defined on a palm-side portion proximate the thumb tube and on an opposing portion proximate the distally remote one of the finger tubes.

The glove as recited in paragraph [0036], wherein the geometrix extends at an angle up to perpendicular relative to the glove surface.

The glove as recited in paragraph [0036], wherein the geometrix is circular in cross-section.

The glove as recited in paragraph [0036], wherein a base of the geometrix has a side-to-side distance of 0.5 mm to 5 mm on a horizontal axis relative to the glove surface.

The glove as recited in paragraph [0036], wherein the geometrix extends to a height in a range from 0.2 mm to 2 mm from the exterior surface.

The glove as recited in paragraph [0036], wherein the concave recess has a diameter in a range of 0.2 mm to 1.5 mm.

The glove as recited in paragraph [0036], wherein the concave recess has a depth in a range of 0.05 mm to 1 mm.

In another aspect, the present invention meets the need in the art by providing a shoe cover with a grip texture for resisting slippage on walking surfaces, comprising a shell having an exterior surface, the shell defining a toe and opposing heel in respective ends of an upper portion and a sole opposing the upper portion with an opening into the shell proximate the heel; and the sole having at least one grip field of a plurality of spaced-apart geomtrix, each geomtrix extending from the exterior surface of the sole to a distal end defining a concave recess therein.

The shoe cover as recited in paragraph [0045], wherein the geometrix extends at an angle up to perpendicular relative to the exterior surface of the sole.

The shoe cover as recited in paragraph [0045], wherein the geometrix is circular in cross-section.

The shoe cover as recited in paragraph [0045], wherein a base of the geometrix has a side-to-side distance of 0.5 mm to 5 mm on a horizontal axis relative to the exterior surface of the sole.

The shoe cover as recited in paragraph [0045], wherein the geometrix extends to a height in a range from 0.2 mm to 2 mm from the exterior surface of the sole.

The shoe cover as recited in paragraph [0045], wherein the concave recess has a diameter in a range of 0.2 mm to 1.5 mm.

The shoe cover as recited in paragraph [0045], wherein the concave recess has a depth in a range of 0.05 mm to 1 mm.

Objects, advantages, and features of the present invention will be readily apparent upon a reading of the following detailed description in conjunction with the drawings.

### BRIEF DESCRIPTION OF THE DRAWINGS

FIG. 1 illustrates in perspective view a glove having a textured geometry field of a plurality of protruding spaced-apart nodules for enhancing a grip on an article in accordance with the present invention.

FIG. 2 illustrates in perspective view an alternate embodiment of a glove having discrete textured geometry fields each of a plurality of the protruding spaced-apart nodules for enhancing a grip on an article in accordance with the present invention.

FIG. 3 illustrates an enlarged detailed perspective view of a portion of the glove surface having the plurality of protruding spaced-apart nodules in a first embodiment of the textured geometry.

FIG. 4 illustrates in top plan view the portion of the glove surface illustrated in FIG. 3.

FIG. 5 illustrates in enlarged detailed cross-sectional view an first embodiment of a nodule.

FIG. 6 illustrates in enlarged detailed cross-sectional view a second embodiment of a nodule.

FIG. 7 illustrates in enlarged perspective view a third embodiment of a nodule.

FIG. 8 illustrates in enlarged side cross-sectional view of the glove surface with a fourth embodiment of a nodule.

FIG. 9 illustrates a glove form for making gloves in accordance with the present invention.

FIG. 10 illustrates in enlarged detailed cross-sectional view a wall portion of the glove form illustrated in FIG. 9.

FIG. 11 illustrates as a schematic diagram a side view of a shoe cover in accordance with the present invention.

FIG. 12 illustrates as a schematic diagram a side perspective view of the shoe cover shown in FIG. 11 angled to illustrate the sole having a field of protruding spaced-apart nodules in accordance with the present invention.

### DETAILED DESCRIPTION

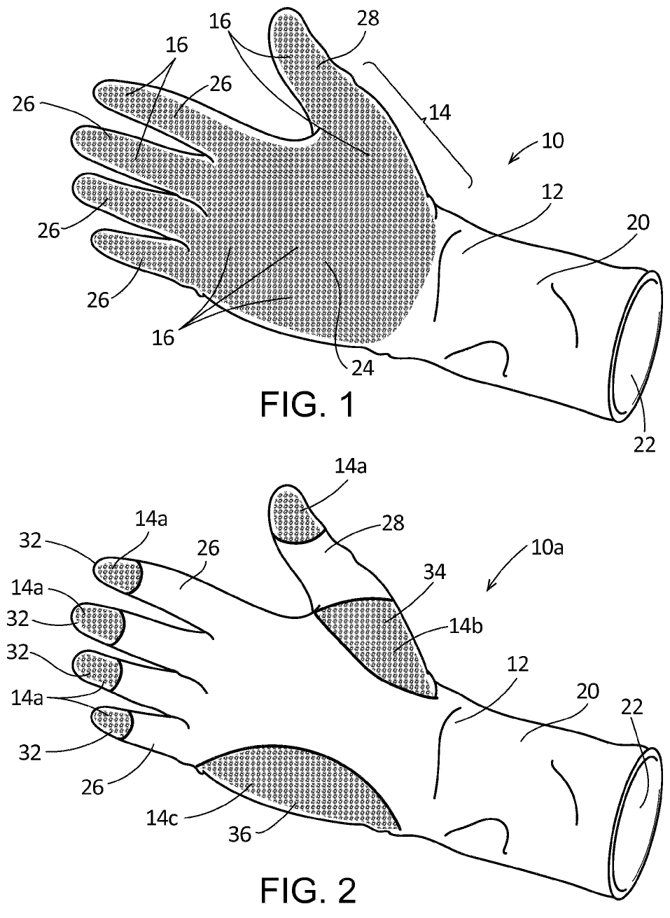

With reference to the drawings, in which like parts have like reference numerals, FIG. 1 illustrates in perspective view an apparel article in the form of a glove 10 having a glove surface 12. The glove surface 12 includes a field generally 14 of a plurality of spaced-apart nodules 16 as textured geometry structure (referenced as a geomatrix or nodule) protruding from the glove surface for enhancing a grip on an article by a person using the glove for glove purposes. The glove 10 includes an elongated cuff 20 that defines an open end 22 for receiving a hand of a person to wear for protective glove purposes. The elongated cuff portion 20 extends to a hand covering 24 and from which four finger tubes 26 and a thumb tube 28 extend.

In the embodiment illustrated in FIG. 1, the field 14 extends across the palm-side of the glove surface 12 including substantially edge-to-edge of the palm, the finger tubes, and the thumb tube. An alternate embodiment 10a illustrated in FIG. 2 includes spaced-apart textured geometry fields in particular palm-side grip portions of the glove. A respective tip portion 32 of each finger tube 26 and the thumb tube 28 includes a geomatrix field 14a. Opposing palm portions 34, 36 proximate the thumb tube 28 and an opposing finger tube 26a each include a respective geomatrix field 14b and 14c for opposed gripping of an article by the closing of a hand of a person wearing the protective glove.

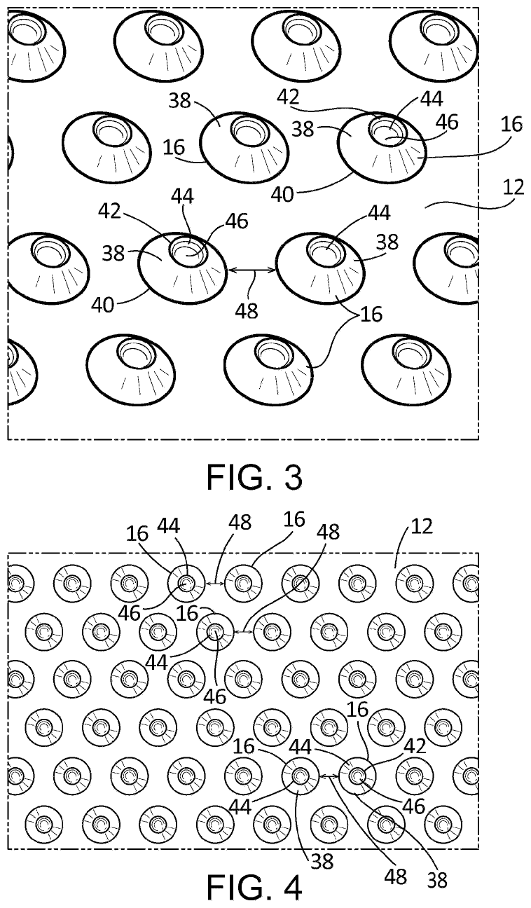

FIG. 3 illustrates an enlarged detailed perspective view of a portion of the glove surface 12 having the plurality of protruding spaced-apart nodules 16 in a first embodiment of the textured geometry. The nodule 16 in the illustrated preferred embodiment defines a truncated geometry, such as a truncated cone, or frustoconical, that is, having the shape of frustum of a cone, or in an alternate embodiment as a truncated pyramid, or frustopyramidal, in shape. The convex member 16 protrudes with sloped sides 38 from a base 40 at the glove surface 12 to a distal extent 42 and defines at the distal extent a concave recess 44 with a concave floor 46. Alternatively, the surface of the inner floor 46 of the recess 44 may be planar but preferably is arcuately curved as an inverted dome-shaped concave floor having a lower apex. The recess 42 at the distal extent facilitates the nodule 16 gripping with suction dynamics when in contact with a surface of an article.

The nodule 16 extends from the glove surface 12 at an angle up to 90 degrees, more preferably angles from the glove surface at a sloped angle in a range of 45±30 degrees inwards towards the smaller top at the distal extent 42, and more preferably sloped at 45 degrees, to have a geometry of a projecting post or stub, more preferably having a geometry of a cone, preferably conical such as volcano or an octopus tentacle. Alternatively, the convex nodule 16 may be pyramidal, such as but not limited to a triangular or rectangular pyramid in cross-sectional side view, or alternatively, may be circular in cross-section.

The grip surface in the field 14 accordingly is formed with the plurality of the convex nodules 16 with the concave recesses 44. The nodules 16 are spaced apart with a gap 48 sufficiently that the film chemistry of which the glove 10 is formed does not readily flow by trapping or surface tension. The spacing 48 thereby prevents the side walls and recesses from robbing the film chemistry through trapping or surface tension. The glove 10 thereby forms with substantially uniform thickness in a lateral line transverse to a longitudinal axis of the glove, although the glove thickness proximate the fingers end may be greater than the glove thickness proximate the cuff end, because the glove formed by dipping has the fingers end of the glove former immersed in the chemistry bath longer than for the last-in cuff-end of the former.

With reference to FIG. 4 that illustrates a detailed top plan view of the portion of the glove surface illustrated in FIG. 3, the nodules 16 are positioned with the bases 40 spaced apart to define the gap distance 48 in a range of 0.1 mm to 3 mm, and preferably 1 mm apart. The base 40 is preferably round, but may be of other geometries such as triangle or rectangle pyramid in cross-section. The diameter at the base 40 of the convex nodule is in a range of 0.5 mm to 5 mm, and preferably 2.3 mm. The diameter or width of the concave recess 44 at the distal extent 42 of the nodule is a range from 0.2 mm to 1.5 mm, and preferably 1 mm. With continuing reference to FIG. 3, the height of the convex nodule 16 from the base 40 to the open edge of the recess 44 at the distal extent 42 is a range of 0.2 mm to 2 mm, and preferably 0.8 mm. The depth of the concave recess 44 at the distal extent 42 is a range of 0.05 mm to 1 mm, and preferably 0.1 mm. As illustrated, the adjacent rows of spaced-apart convex nodules 16 are preferably disposed in a staggered off-set pattern, which may be evenly or uniformly staggered but may be aligned in series or offset slightly. The adjacent rows may be oriented in another embodiment in aligned linear row and column grid.

The spacing gap 48 may be a distance that is between about 1:2 to about 3:2 relative to the height of the nodule 16 extending from the glove surface 12. The spacing gap 48 may be a distance that is between about 1:1.15 to about 1:5 relative to the width of the nodule 16.

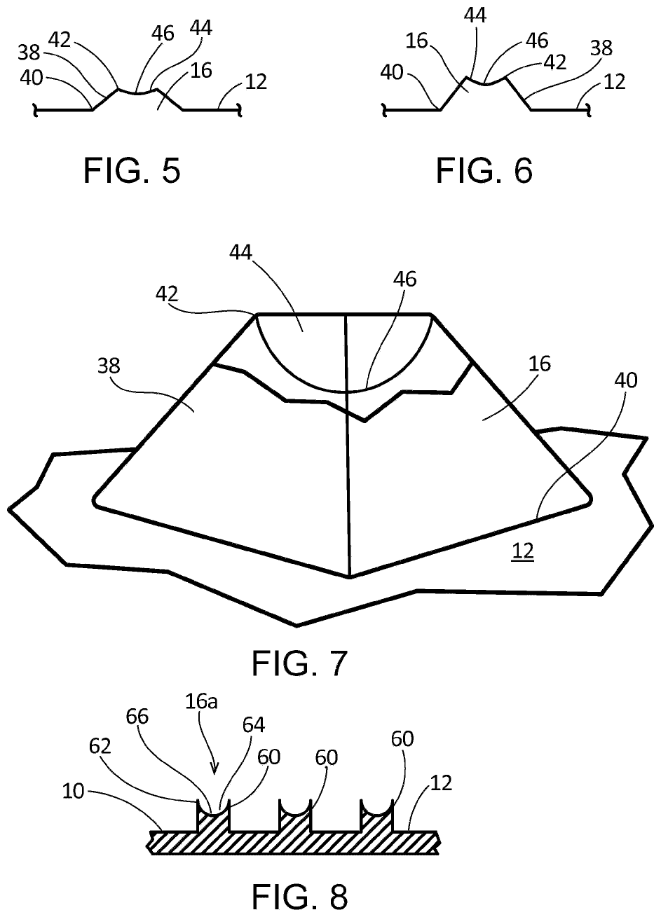

FIG. 5 illustrates in enlarged detailed cross-sectional view a first embodiment of a nodule 16 projecting from the glove surface 12 with a height of 0.4 mm and a base diameter of 2.29 mm. The diameter of the concave recess 44 is 1.03 mm, and a depth of 0.2 mm.

FIG. 6 illustrates in enlarged detailed cross-sectional view a second embodiment of a nodule 16 projecting from the glove surface 12 with a height of 0.8 mm and a base diameter of 2.29 mm. The diameter of the concave recess 44 is 1.03 mm, and a depth of 0.2 mm.

FIG. 7 illustrates in enlarged perspective cut-away view a third embodiment of a nodule 16 having a rectangular convex shape and defining the concave recess 44 at the distal extent 42.

FIG. 8 illustrates in enlarged side cross-sectional view the glove surface 12 with a fourth embodiment of the nodule 16a extending as a stub or post 60 to a distal end 62 and defining a concave recess 44 having a dome-shaped floor 46. In this embodiment, the post 60 extends perpendicularly from the glove surface 12 in spaced-relation to adjacent posts 60.

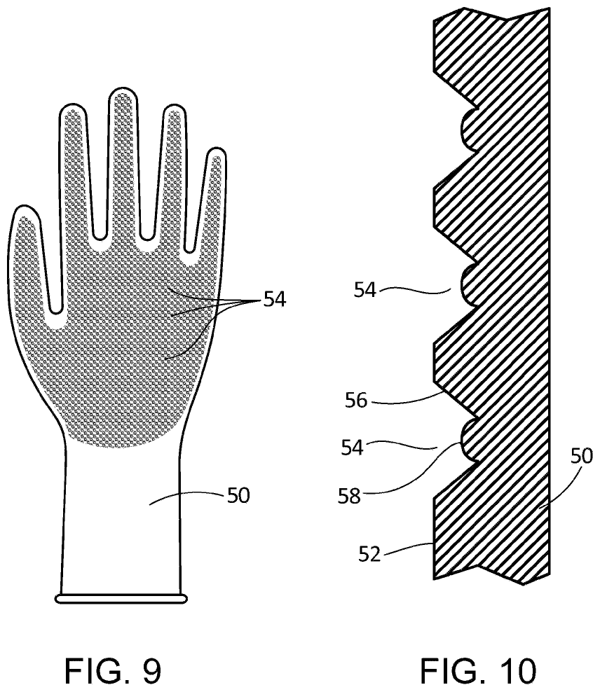

FIG. 9 illustrates a glove form 50 for making gloves in accordance with the present invention. The form 50 may be ceramic, metal, or plastic. The geometry on the former 50 is the inverted format from the finished glove 12. The exterior wall 52 of the form 50 defines a plurality of spaced-apart recesses 54 conforming in shape for forming the protruding nodules 16 when the glove form 50 is dipped conventionally in a chemistry bath of a fluidal material, preferably polymeric, of which the glove is made. The recess 50 has a side wall 54 and floor 58 conforming to the geometry of the nodule 16. The gloves 12 are made using the former 50, for example carried by large chain line-driven forming machines or alternatively carried with other formers in a batch dip process. The former 50 (or a plurality of formers) are pulled through the manufacturing/dipping process rotating through multiple dipping and processing steps conventional in the industry. The illustrated former 50 yields the glove 10 illustrated in FIG. 1. A batch process moves a group of formers (for example, carried on a pallet) into the various stations of the process. For example, the pallet carrying the formers moves into a dipping station having the chemistry bath, and then out for drying or moving to the next station, with another pallet of formers moving to the vacated station.

An alternate former (not illustrated) provides recesses in selected portions, for example but not limited to an embodiment providing nodules 16 in the finger-tip (and thumb-tip) portions 32, 34, an embodiment providing nodules 16 on the full length of the respective finger tubes 26 and thumb tube 28, nodules 16 in the palm gripping portions 34, 36, or both finger and thumb tips and the palm gripping portions to yield the glove illustrated in FIG. 2.

FIG. 10 illustrates in enlarged detailed cross-sectional view a wall portion of the glove former 50 illustrated in FIG. 9. The exterior wall 52 defines the spaced-apart recesses 54 that each extend inwardly from the wall 52 to define the side wall 56 and further inwardly the interior floor 58. The interior floor 58 in the illustrated embodiment curves as a dome towards the opening in the exterior wall 52 for defining the concave recess 44 during the dipping manufacturing process.

It is to be appreciated that the glove 10 per standard description includes the cuff 20, the hand covering 24, and the extending four finger tubes 26 and one thumb tube 28. The glove 10 of the present invention can be manufactured in an ambidextrous form where the glove can be used on either left or right hand. In the ambidextrous embodiment, the field(s) 14 may be defined on both outward surfaces consistent with the characteristic for positioning of the glove on either hand. Alternatively, the glove can be manufactured for use in a hand-specific format where the thumb is rotated towards the palm, thus designating the glove for wearing on the appropriate right hand or left hand. Generally, a hand-specific form allows for a more ergonomic shape.

With reference to FIG. 9, the former 50 is used in a glove forming apparatus, conventionally a production line of stations for preparing the formers for making of the gloves 10, dipping the formers for periods in chemistry baths, finishing the gloves, and stripping the finished gloves from the respective formers, and repeating. Conventionally, the gloves are manufactured in the production line configured for cleaning of the formers 50 such as with acid and base fluids and brushes to wipe the formers; drying; coagulant dip (such as a calcium nitrate salt +powder or wax bath); drying; a chloroprene mixture or a latex/nitrile dip in a chemistry bath with materials suitable for the intended use of the protective glove; optionally, a second dip for quality and/or glove performance purposes; partial drying; beading; leaching; polymer or powder slurry dip; drying; and stripping finished gloves from the formers.

As discussed above, the former 50 typically inverts for insertion fingers-end first into the chemistry bath(s) and the cuff portion last-in. The spacing gap 48 of adjacent nodules 16 defined by the recesses 54 in the former 50 provides resistance to materials robbing from the recesses and land portions of the surface 52 during chemistry bath dipping by surface tension and physical trapping for providing substantially uniform thickness along a line transverse to the longitudinal axis while the glove thickness generally is greater at the fingers-end of the glove relative to the line than a cuff-end of the glove relative to the line because of such having extended dwell in the chemistry baths.

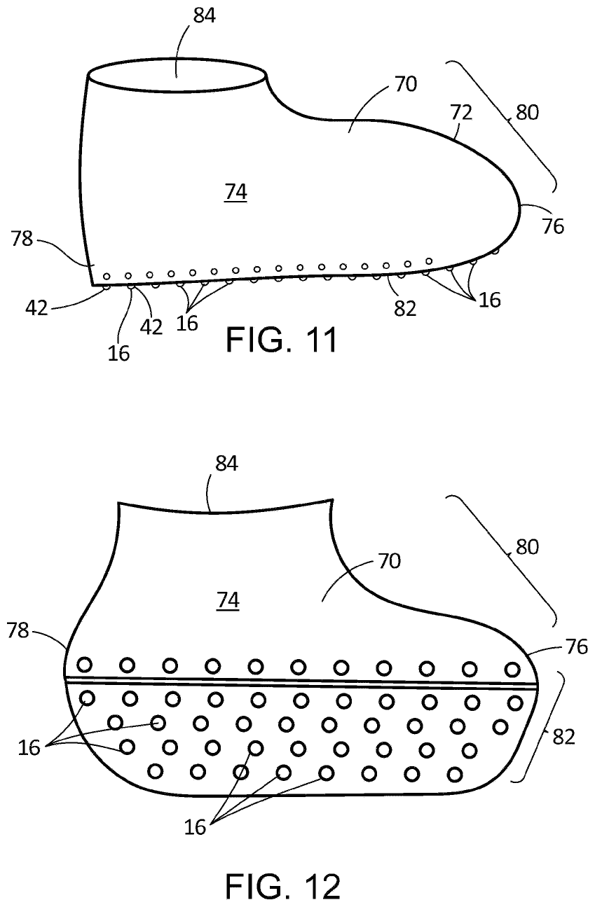

The forgoing discusses embodiments of protective gloves as apparel articles in accordance with the present invention while shoe covers are yet another apparel article gainfully embodying the grip texturizing of the present invention. FIG. 11 illustrates as a schematic diagram a side view of a shoe cover 70 a grip texture for gripping, and more particularly, resisting slippage on walking surfaces in accordance with the present invention. The shoe cover 70 comprises in the illustrated embodiment a shell 72 dip-formed on a former of a shoe shape as discussed above relative to the glove embodiment of the apparel article. The shell 72 of the shoe cover 70 has an exterior surface 74 with a toe 76 and opposing heel 78 in respective ends of an upper portion 80 and a sole 82 opposing the upper portion, with an opening 84 into the shell proximate the heel, for receiving therein footwear for protective covering. The sole 82 has at least one grip field of a plurality of spaced-apart geomtrix or nodules 16 (illustrated without scale), each extending from a base 40 at the exterior surface 74 of the sole to the distal extent 42 and defining at the distal extent the concave recess 44.

FIG. 12 illustrates as a schematic diagram a side view perspective view of the shoe cover 70 angled to illustrate the sole 82 having the field of protruding spaced-apart nodules 16 extending from the exterior surface 74 (again, depicted without scale for illustration purposed). Further, the illustrated embodiment optionally includes one or more rows of spaced-apart nodules 16 on a sidewall of the shoe upper 80 proximate the edge of the sole 82.

The field of spaced-apart nodules 16 enhance gripping of walking surfaces while providing protective covering of footwear of a wearer using the shoe cover 70. In an alternate embodiment (not illustrated) the sole defines first and second spaced-apart fields of the plurality of nodules 16 proximate the toe 76 and heel 78.

Generally, the geometrix or nodule 16 extends at an angle up to perpendicular relative to the exterior surface of the sole 82. The geometrix or nodule 16 in an embodiment may be circular in cross-section, or geometric such as triangularly pyramidal as discussed above. A base of the geometrix has a side-to-side distance of 0.5 mm to 5 mm on a horizontal axis relative to the exterior surface of the sole. The geometrix extends to a height in a range from 0.2 mm to 2 mm from the exterior surface of the sole. The concave recess has a diameter in a range of 0.2 mm to 1.5 mm and a depth in a range of 0.05 mm to 1 mm.

The foregoing describes in alternate embodiments an improved grip texture of geometrix nodules formed in apparel articles, and more particularly in illustrative embodiments of protective rubber gloves and shoe covers made from natural and synthetic rubbers. Current available protective gloves, while using grip textures to improve the grip of the wearer on an article being grasped when performing glove purpose tasks, have drawbacks. The grip texture of the present invention made of a plurality of spaced convex nodules each having the concave recess top or distal extend, create the suction dynamic at the points of griping contacts. When the user grips article, each nodule 16 acts as a small suction point in order to create an improved grip. The present protective glove exhibits enhanced and improved overall grip. In addition to the improved grip by use of suction nodules, there are some other features and improvements. Traditional grip texture geometries create thick and thin spots on the glove on the portion of the glove that is textured due to surface tension and the physical trapping of coagulant. The raised spots of the textured glove tend to rob the other parts of the glove of material which creates a “weak spot” on the glove. The present surface texture feature described in the foregoing reduces weakened portions by providing sufficient gap space between each nodule that makes the texture to reduces the tendency of the material to be “robbed” to the protruding nodule. Further, shoe covers gainfully provide enhanced resistance to slippage while working or or walking over surfaces such as but not limited to contaminated, wet, or petrochemical spill surfaces.

Typical specifications (per current ASTM standards from natural and synthetic gloves), for gloves in accordance with the present invention:
Thickness at palm ranging from 3 mil to 20 mil
Length from middle finger tip to cuff from 200 mm to 400 mm
Tensile strength>14 Mpa
Elongation>400%
Sizes from XXS to 4XL
Variety of colors including, but not limited to white, yellow, amber, blue, green, red, orange, black, and purple.

The foregoing discloses the protective dip-formed protective apparel articles, particularly gloves featuring the field of the plurality of the geometric protruding nodules each with the concave recess at the distal extent for providing the enhanced suction dynamic gripping of the article when using the gloves for glove purposes and shoe covers having soles featuring the field of the plurality of the geometric protruding nodules each with the concave recess at the distal extent for providing the enhanced suction dynamic gripping for slippage resistance when using the shoe covers for protective covering purposes. It is to be appreciated that while the invention has been disclosed in alternate illustrative embodiments, variations and changes may be made by one of ordinary skill in the art without departure from the invention as recited in the claims.

1. An apparel article, comprising:
a protective shell with an opening for receiving therethrough a portion of a person to wear the apparel good; and
at least one grip field having a plurality of spaced-apart nodules, each nodule extending from an exterior surface of the protective shell to a distal end defining a concave recess therein.

2. The apparel article as recited in claim 1, wherein each nodule defines a geometrix with a base at the exterior surface having a width in a range 0.5 mm to 5 mm, extends to a height in a range from 0.2 mm to 2 mm from the exterior surface, and the concave recess has a depth of 0.05 mm to 1 mm, and adjacent ones of the plurality of nodules are spaced apart in a range of 0.1 mm to 3 mm.

3. The apparel article as recited in claim 1, wherein the protective shell defines a glove having a hand portion from which four finger tube and a thumb tube extend.

4. The apparel article as recited in claim 1, wherein the protection shell defines a shoe covering.

5. The apparel article as recited in claim 1, wherein each nodule extends to a height in a range from 0.2 mm to 2 mm from the exterior surface, optionally to a height of 0.8 mm.

6. (canceled)

7. The apparel article as recited in claim 1, wherein the concave recess has a diameter of 0.2 mm to 1.5 mm, optionally wherein the concave recess has a diameter of 1 mm.

8. (canceled)

9. The apparel article as recited in claim 1, wherein the concave recess has a depth of 0.05 mm to 1 mm, optionally wherein the concave recess has a depth of 0.1 mm.

10. (canceled)

11. The apparel article as recited in claim 1, wherein the nodule extends outwardly with a side wall up to 90 degrees relative to the exterior surface, optionally wherein the nodule angles to the distal end in a range of 15 degrees to 75 degrees relative to the exterior surface, and optionally wherein the nodule angles to the distal end at 45 degrees relative to the exterior surface.

12. (canceled)

13. (canceled)

14. The apparel article as recited in claim 1, wherein the nodule has a base at the exterior surface with a width in a range 0.5 mm to 5 mm, optionally wherein the nodule has a base at the exterior surface with a width of 2.3 mm.

15. (canceled)

16. The apparel article as recited in claim 1, wherein adjacent ones of the plurality of nodules are spaced apart in a range of 0.1 mm to 3 mm, optionally wherein adjacent ones of the plurality of nodules are spaced 1 mm apart.

17. (canceled)

18. The apparel article as recited in claim 1, wherein the nodule defines a conical geometric shape with a base at the exterior surface having a width in a range 0.5 mm to 5 mm, extends to a height in a range from 0.2 mm to 2 mm from the exterior surface, and the concave recess has a depth of 0.05 mm to 1 mm, and adjacent ones of the plurality of nodules are spaced apart in a range of 0.1 mm to 3 mm.

19. The apparel article as recited in claim 3, wherein the hand portion defines at least one pad portion; and the at least one grip field occupies the at least one pad portion.

20. The apparel article as recited in claim 19, wherein the at least one grip field occupies a palm side tip portion of at least one of the four finger portions and the thumb portion.

21. The apparel article as recited in claim 19, wherein each of the four finger tubes and the thumb tube have a respective palm-side tip portion and each respective palm-side tip portion having a respective one of the at least one grip field of the plurality of nodules.

22. The apparel article as recited in claim 3, wherein the at least one pad portion is on a palm-side proximate the thumb tube.

23. The apparel article as recited in claim 22, further comprising a second one of the at least one pad portion on a palm side proximate a finger tube most distally remote from the thumb tube; and further comprising a second one of the at least one grip field that occupies the second one of the at least one pad portion.

24. The apparel article as recited in claim 1, wherein the plurality of spaced-apart nodules are disposed in rows.

25. The apparel article as recited in claim 24, wherein the spaced-apart nodules in a first row are offset from the spaced-apart nodules in an adjacent row.

26. The apparel article as recited in claim 1, wherein a shape of the nodule is selected from a group comprising shapes that are conical, pyramidal, and circular in cross-section.

27. (canceled)

28. (canceled)

29. The apparel article as recited in claim 4, wherein the exterior surface of the protective shell comprises a sole portion of the shoe covering.

30. A glove with a grip texture, comprising a glove body having an exterior surface, with a cuff having an open end and extending to a hand portion from which four finger tubes and a thumb tube extends, for receiving a hand therein; and at least one grip field having a plurality of spaced-apart geomtrix, each extending from the exterior surface to a distal end defining a concave recess therein.

31. The glove as recited in claim 30, wherein the grip field is defined on a respective palm-side tip portion of the finger tubes and the thumb tube.

32. The glove as recited in claim 30, wherein the grip field is defined on a palm- side portion proximate the thumb tube and on an opposing portion proximate the distally remote one of the finger tubes.

33. The glove as recited in claim 30, wherein the geometrix extends at an angle up to perpendicular relative to the glove surface.

34. The glove as recited in claim 30, wherein the geometrix is circular in cross-section.

35. The glove as recited in claim 30, wherein a base of the geometrix has a side-to-side distance of 0.5 mm to 5 mm on a horizontal axis relative to the glove surface.

36. The glove as recited in claim 30, wherein the geometrix extends to a height in a range from 0.2 mm to 2 mm from the exterior surface.

37. The glove as recited in claim 30, wherein the concave recess has a diameter in a range of 0.2 mm to 1.5 mm.

38. The glove as recited in claim 30, wherein the concave recess has a depth in a range of 0.05 mm to 1 mm.

39. A shoe cover with a grip texture for resisting slippage on walking surfaces, comprising a shell having an exterior surface, the shell defining a toe and opposing heel in respective ends of an upper portion and a sole opposing the upper portion with an opening into the shell proximate the heel; and the sole having at least one grip field of a plurality of spaced-apart geomtrix, each geomtrix extending from the exterior surface of the sole to a distal end defining a concave recess therein.

40. The shoe cover as recited in claim 39, wherein the geometrix extends at an angle up to perpendicular relative to the exterior surface of the sole.

41. The shoe cover as recited in claim 39, wherein the geometrix is circular in cross-section.

42. The shoe cover as recited in claim 39, wherein a base of the geometrix has a side-to-side distance of 0.5 mm to 5 mm on a horizontal axis relative to the exterior surface of the sole.

43. The shoe cover as recited in claim 39, wherein the geometrix extends to a height in a range from 0.2 mm to 2 mm from the exterior surface of the sole.

44. The shoe cover as recited in claim 39, wherein the concave recess has a diameter in a range of 0.2 mm to 1.5 mm.

45. The shoe cover as recited in claim 39, wherein the concave recess has a depth in a range of 0.05 mm to 1 mm.
